(19) United States
(12) Patent Application Publication
(10) Pub. No.: US 2008/0162284 A1
(43) Pub. Date: Jul. 3, 2008

(54) SYSTEM AND METHOD FOR CONDUCTING ELECTRONIC COMMERCE AND PROVIDING INCENTIVES THEREIN

(75) Inventor: Vincent Villano, Wethersfield, CT (US)

Correspondence Address: MICHAUD-DUFFY GROUP LLP, 306 INDUSTRIAL PARK ROAD, SUITE 206, MIDDLETOWN, CT, 06457, US

(73) Assignee: CLARUS MARKETING GROUP, LLC, Wethersfield, CT (US)

(21) Appl. No.: 11/964,237

(22) Filed: Dec. 26, 2007

Related U.S. Application Data
(60) Provisional application No. 60/877,510, filed on Dec. 27, 2006.

(51) Int. Cl. G06Q 30/00

(52) U.S. Cl. 705/14

(57) ABSTRACT

A system is provided for conducting electronic commerce and for increasing a conversion rate of visitors to a specific online merchant's website by promoting an incentive. The incentive is designed to encourage the customers to complete a purchase of goods and/or services offered by the online merchant. In one embodiment, the incentive offer is related to the desired transaction such as free shipping, merchandise discount, or a rebate. The incentive offer appears in various places on a specific merchant's website such as, for example, a home page, a shipping page, or in a shopping cart. The incentive offer is redeemed by connecting to a service provider website via a hyperlink after the purchase is complete, or directly from the page where the incentive offer is displayed. Once connected to the service provider website, the customer accepts the offer. By promoting the incentive offer, a merchant increases the number of purchases for their goods and/or services, with the service provider funding the cost of the incentive.

### CROSS REFERENCE TO RELATED APPLICATIONS

This patent application claims priority benefit under 35 U.S.C. §119(e) of copending, U.S. Provisional Patent Application Ser. No. 60/877,510, filed Dec. 27, 2006. The disclosure of the aforementioned U.S. patent application is incorporated by reference herein in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the United States Patent and Trademark Office files or records, but otherwise reserves all copyright rights whatsoever.

### BACKGROUND OF THE INVENTION

1. Field of the Invention

This invention relates to methods and systems for conducting electronic commerce transactions over a distributed communications network such as, for example, the Internet, and more specifically, the World Wide Web portion thereof. Businesses using this framework are commonly referred to as online merchants. In one embodiment, the invention includes a third party service provider that supplies a specific online merchant's customers with a collection of benefits bundled into a subscription package. This service and related benefits may be branded as a separate club, membership, or package; or service and related benefits may be private labeled with the brand of the merchant. In either case, the service provider administers and services the bundled benefits.

2. Description of the Related Art

Online merchants are faced with an ongoing problem of converting visitors to their web site into purchasers. As described herein, a conversion rate of visitors of a website is the number of people who buy a good and/or service divided by the number of visitors to a specific merchant's website. Accordingly, at least one objective of the present invention is to increase the conversion rate for online merchants by reducing the number of customers who abandon a merchant's shopping cart. A shopping cart, as is generally known in the art, is a piece of software that facilitates the ordering process for an on-line merchant. Typically, a shopping cart is the interface between a company's website and its deeper infrastructure, allowing consumers to select merchandise, review what they have selected, make necessary modifications or additions, and purchase the merchandise. As described herein, a shopping cart is considered abandoned when a visitor to the merchant's website selects an item to be added to the shopping cart, but never completes a transaction to purchase the selected item.

The higher the conversions rate of website visitors and the lower the abandoned rate of the shopping cart, the more profitable an online merchant becomes. Positively impacting these ratios are ongoing objectives for online merchants.

As such, the inventor has recognized that there is a clear need for online merchants to leverage methods to maximize their online conversion rates, and decrease their abandoned shopping cart ratios, while still maintaining or improving their profit margins.

### SUMMARY OF THE INVENTION

In one embodiment, the present invention provides a solution to the objectives above by providing a method to make available an incentive offer to the customers of a specific online merchant, sponsored by a third party service provider. A visitor to a specific online merchant website views the incentive offer and, in turn, is more likely to make the purchase knowing that the incentive offer is available. The incentive offer is related to a commerce activity on the merchant website such as, for example, receiving a rebate on shipping charges or receiving cash back on an order they are about to place. In one embodiment, a banner ad or text description describing the incentive offer is placed in strategic locations on the merchant website such as, for example, the home page, product description pages, or shopping cart. In one embodiment, more detailed information on the incentive offer is viewed by selecting, e.g., “clicking on” an image that can open to a new web page or a small popup window explaining the offer in more detail. A perceived advantage of the present invention is that by placing the incentive offer description specifically in the shopping cart it is expected to impact the shopping cart abandoned rate, since a customer would see the incentive offer for the first time on that page. In one embodiment, the third party service provider makes the incentive offer available in conjunction with a collection of benefits bundled into a subscription package.

The customer accepts the incentive offer by connecting via hyperlink, or other electronic method, to the service provider's website. In one embodiment, this hyperlink is placed either directly from the banner ad or text description prior to the completion of the sale, or from the banner ad or text description after the customer completes the online order. If the customer opts to connect to the service provider website, they can view all of the details, and register for the incentive offer and service provider benefit package. If the incentive offer is accepted prior to the sale being completed, the customer receives instructions regarding how to redeem the incentive offer, for example, by way of rebate submission instructions, or a data code which can be entered directly into the appropriate form field on the merchant website. The customer then connects back to the merchant website to complete the order.

### BRIEF DESCRIPTION OF THE DRAWINGS

The features and advantages of the present invention will be better understood when the Detailed Description of the Preferred Embodiments given below is considered in conjunction with the figures provided.

FIG. 1 is a simplified block diagram of a distributed communication network for conducting electronic commerce transaction sin accordance with one embodiment of the present invention.

FIGS. 2 and 2a illustrate merchant web pages for presenting incentive offers to prospective consumers, in accordance with embodiments of the present invention.

FIG. 3 illustrates a merchant shopping cart web page for facilitating an electronic commerce transaction and for presenting an incentive offer to prospective consumers.

FIG. 4 illustrates an order confirmation web page for completing an electronic commerce transaction and for presenting an incentive offer to prospective consumers.

FIGS. 5 and 5a are simplified process flow diagrams depicting steps for accepting incentive offers, in accordance with embodiments of the present invention.

In these figures like structures are assigned like reference numerals, but may not be referenced in the description of all figures.

### DETAILED DESCRIPTION OF THE PREFERRED EMBODIMENTS

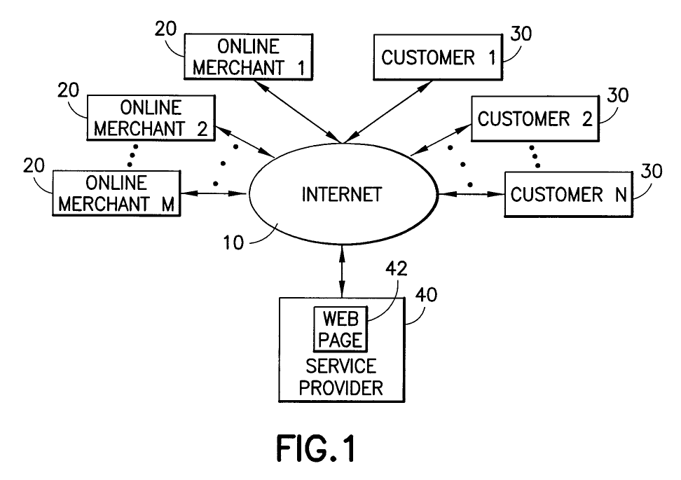

FIG. 1 is a simplified block diagram of a distributed communication network shown generally at 10 such as, for example, the Internet, a Local Area Network (LAN), a Wide Area Network (WAN), Extranet, or the like, for conducting electronic commerce transactions between various merchant websites 1-M, shown generally at 20, and potential customers 1-N, shown generally at 30 of said merchants. As is generally known to those of ordinary skill in the art, the merchants 20 and customers 30 communicate and exchange data by means of local computers and host servers coupled via wired or wireless communication channels. As is known in the art, the aforementioned local computers and host servers include processing means (e.g., CPUs) having transmission means for receiving and transmitting data (e.g., transmitters and receivers such as modems and the like), and database storage means for storing information in database files. Also connected to the network 10 is a service provider server, shown generally at 40, and a website 42 that allow for ease of connectivity for customers 30 to claim an incentive offer, as is described in detail below.

In one embodiment, the incentive offer is designed to encourage a customer 30 to complete a transaction at the merchant website (e.g., purchase a product or service offered by the merchant), at the time they are viewing the offer. The incentive offer is related to the merchant transaction such as, for example, a rebate on the shipping charges, free shipping, a percentage off the transaction, a specific dollar amount off the transaction, an enhanced warranty, and the like. In one embodiment, the incentive offer is redeemed via rebates, coupon codes, or an immediate discount or rebate.

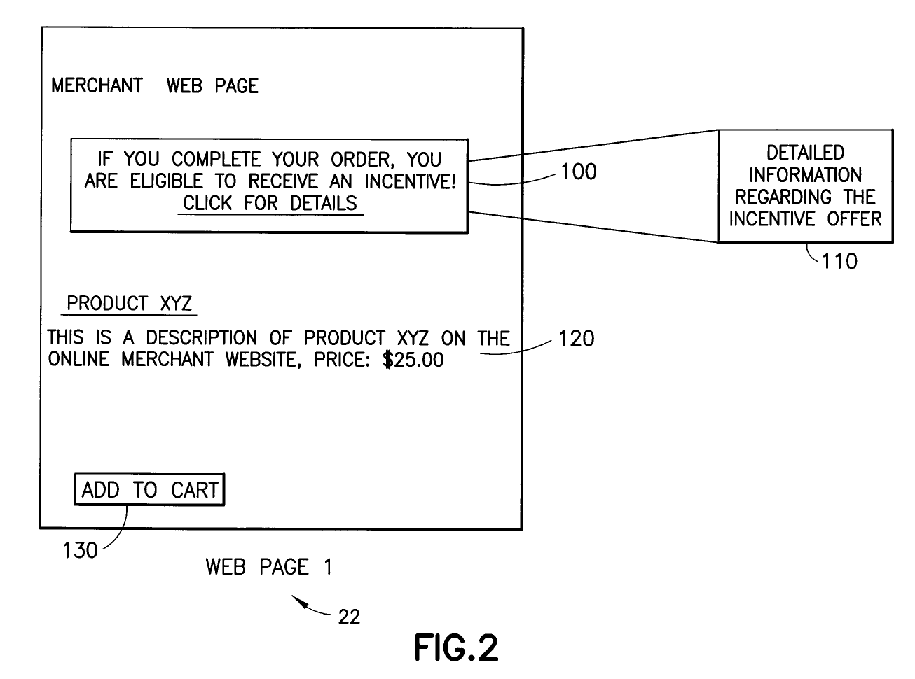

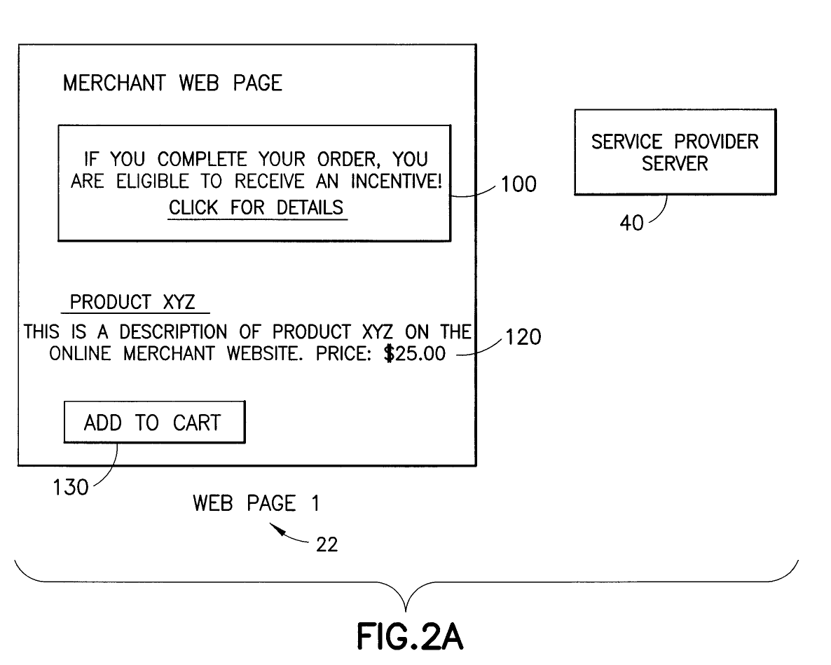

FIG. 2 depicts an incentive offer 100 displayed on a merchant web page 22 (web page 1) such as, for example, a main home page or index page of the merchant website, a page which displays details on the products or services of the merchant, or a page which outlines supporting details of a purchase, such as shipping charges. When a customer accesses the merchant web page 22 (e.g., Web Page 1) the incentive offer 100 is displayed as, for example, descriptive text, a banner image, or a combination of both. In one embodiment, an optional step of selecting, e.g., “clicking on”, the incentive 100, e.g., an image or a text hyperlink, invokes a pop-up window 110 detailing more information on the incentive offer 100. As the customer reviews information, shown generally at 120, describing a product offered by the merchant, e.g. Product XYZ, they now have an ability to consider the incentive offer 100 when evaluating and making a purchase decision. In one embodiment, the incentive offer text and and/or images 100 is hosted directly on the merchant servers, e.g., one of the merchants 1-M shown at 20 of FIG. 1, or accessed remotely from the service provider's servers, e.g., service provider 40 of FIG. 1. Remote access from the service provider's server 40 is transparent to the customer. FIG. 2a represents, for example, a variation of the offer displayed on a web page as depicted in FIG. 2. As shown in FIG. 2a, selecting a hyperlink connects the customer directly to the service provider's website 42, e.g., service provider 40 of FIG. 1.

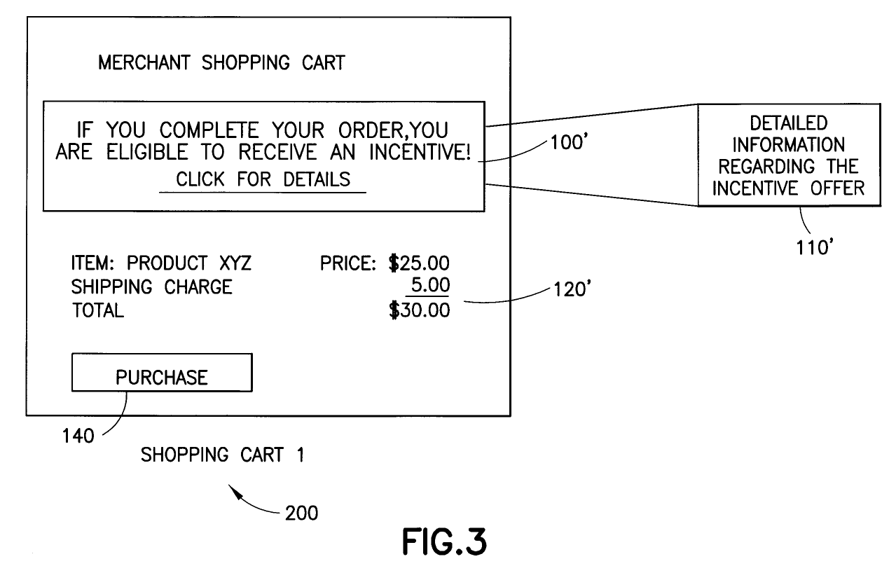

FIG. 3 depicts an incentive offer 100′ displayed on a merchant shopping cart, e.g., Shopping Cart 200, that serves as an interface between a company's website and its deeper infrastructure, allowing consumers to select merchandise; review what they have selected; make necessary modifications or additions; and purchase the merchandise. When a customer views their shopping cart 200 (e.g., Shopping Cart 1) the incentive offer 100′ is displayed either in descriptive text, as a banner image, or a combination of both. In one embodiment, an optional step of selecting e.g., “clicking on” the image or a text hyperlink 100′ produces a pop-up window 110′ detailing more information on the incentive offer 100′. As the customer reviews selected merchandise and transactional information 120′ corresponding to a purchase of the merchandise selected and displayed in their Shopping Cart 1, they have the ability to consider the incentive offer 100′ before continuing with the transaction by selecting the Purchase button 140. The incentive offer text and and/or images 100′ can be hosted directly on the merchant servers 1-M 20, or accessed remotely from the service provider's server 40. Remote access from the service provider's server 40 is transparent to the customer.

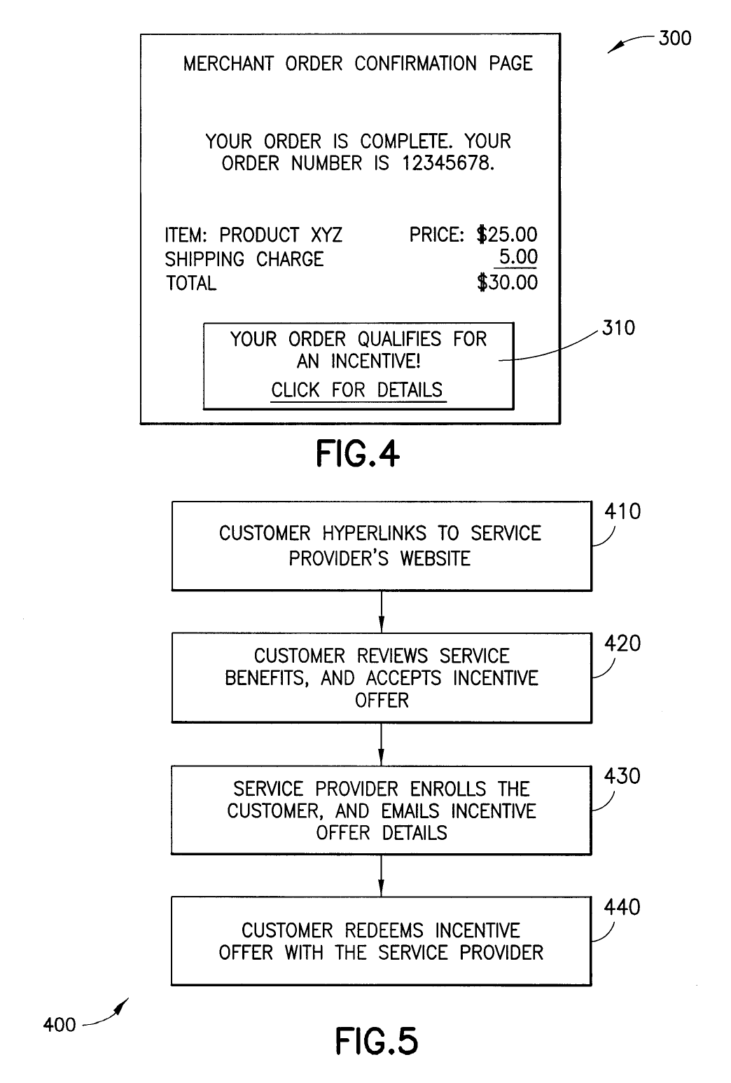

FIG. 4 depicts one embodiment of an order confirmation page, shown generally at 300, invoked after the customer has completed a purchase transaction, e.g. provided purchasing information (e.g.. a source of funds to complete a purchase) as is generally known in the art, and has proceeded through the shopping cart process. A description of the incentive offer is once again displayed at 310, this time with a hyperlink to the service provider's website 42.

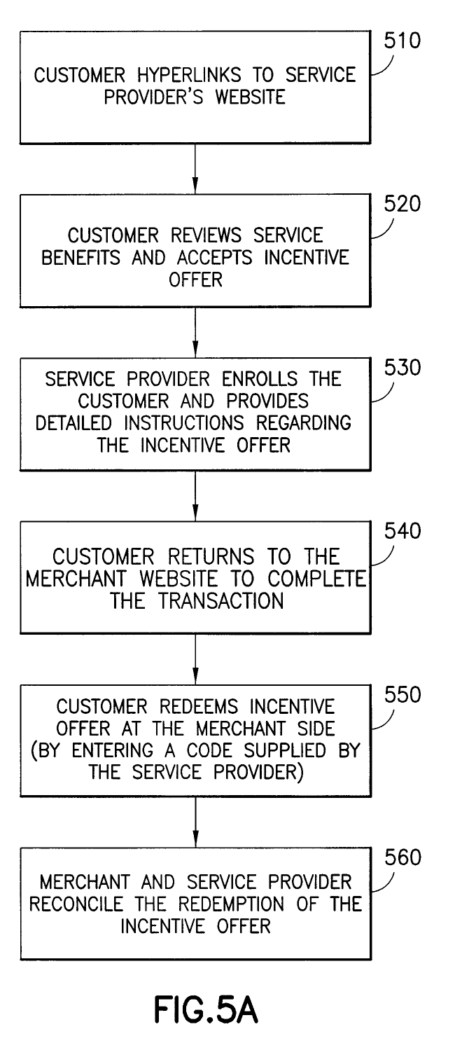

FIG. 5 is a simplified process flow diagram 400, in accordance with one embodiment of the present invention, which represents steps a service provider takes once a customer selects (e.g., clicks) at Step 410 a hyperlink to the service provider's website. Once at the service provider's website, the customer reviews, at Step 420, benefits available through the service provider, and decide to accept an incentive offered by the service provider. If the incentive offer and benefit package is accepted, at Step 430, details of both are delivered (e.g., emailed) to the customer, and made available on the service provider's website 42. At Step 440, the customer also receives detailed instructions on how to redeem the incentive offer.

FIG. 5a is a process flow diagram 500, in accordance with one embodiment of the present invention, which represents steps a service provider takes once a customer selects a hyperlink to the service provider's website 42 at Step 510, prior to the completion of the transaction. Once at the service provider's website 42, the customer reviews the benefits available through the service provider, and decides to accept an incentive offer at Step 520. If the incentive offer and benefit package is accepted, the details of both are emailed to the customer, and made available on the service provider's website at Step 530, which may include a data code the customer can enter directly into the appropriate database form field on the merchant's website at Step 540, which will allow the customer to receive the benefit of the incentive offer at Step 550. In one embodiment, this benefit is related to the specific transaction such as, for example, free or discounted shipping, a percentage discount on the purchase price, or a specific dollar value off the purchase price. The merchant and service provider reconciles the number of incentive offer redemptions at Step 560, which have been redeemed, and settlement is made to the merchant from the service provider, as agreed upon between the parties.

One or more embodiments of the present invention have been described. Nevertheless, it will be understood that various modifications may be made without departing from the spirit and scope of the invention.

What is claimed is:

1. A computer-implemented method for providing incentives in electronic commerce transactions to encourage sales of goods and/or services to potential customers over a distributed network, comprising:
providing an information processing system containing service provider, merchant and customer processing means having transmission means for receiving and transmitting data, and database storage means for storing information in database files;
receiving customer commands specifying a particular good and/or service to be purchased from the merchant;
storing information pertaining to goods and/or services selected for purchase;
comparing the selected goods and/or service with a list of incentives;
displaying an incentive offer and information describing the selected goods and/or service to the customer;
wherein when the customer accepts the incentive offer, enrolling the customer in an incentive program; and
redeeming the incentive offer by the service provider in accordance with conditions of the incentive program.

2. The method of claim 1 wherein the list of incentives includes at least one of free shipping services, discounted shipping services, a percentage discount on a purchase price of the selected goods and/or services, a specific dollar value off a purchase price of the selected goods and/or services, and an enhanced warranty related to the selected goods and/or service.

3. The method of claim 1 wherein the step of displaying includes displaying the incentive offer and information describing the goods and/or services on a merchant web page exhibited on the customer processing means.

4. The method of claim 1, further including displaying a link, which when selected, provides detailed information regarding the incentive offer.
